(19) United States
(12) Patent Application Publication
(10) Pub. No.: US 2006/0159604 A1
(43) Pub. Date: Jul. 20, 2006

(54) Pretreatment of refractory titaniferous ores

(76) Inventors: Dirk Edmond Verhulst, Reno, NV (US); Bruce James Sabacky, Reno, NV (US); Jeffrey Spencer Lang, Reno, NV (US)

Correspondence Address: BRINKS HOFER GILSON & LIONE, P.O. BOX 10395, CHICAGO, IL, 60610, US

(21) Appl. No.: 11/298,764

(22) Filed: Dec. 9, 2005

Related U.S. Application Data
(60) Provisional application No. 60/635,284, filed on Dec. 10, 2004.

(51) Int. Cl. C22B 34/10; C01G 23/00; C01G 25/00; C01G 27/00

(52) U.S. Cl. 423/69; 423/71

(57) ABSTRACT

A process for increasing the solubility of titanium in oxidized titanium compounds, titaniferous ore, ore concentrate, or mixtures thereof. The process includes adding an iron compound to the titaniferous ore or ore concentrate, mixing to form a mixture, heating under a controlled atmosphere to form an iron-titanium compound, cooling, and milling to form a powder. The solubility in concentrated hydrochloric acid of the titanium in the powder is greater than the solubility of the titanium in the titaniferous ore or ore concentrate.

The present application claims priority to U.S. Ser. No. 60/635,284 filed Dec. 10, 2004, the entire contents of which are incorporated herein by reference.

The present invention relates to the processing of titaniferous ore or ore concentrate to titanium dioxide or titanium metal. Particularly, the process relates to a novel pretreatment step to make certain refractory ores amenable to leaching or digestion.

### BACKGROUND

U.S. Pat. No. 6,375,923 discloses a process to make titanium dioxide pigment from titaniferous ore. This process is particularly well suited to the treatment of unaltered ilmenite ores. Unaltered ilmenite, FeO.TiO₂, is soluble in highly concentrated hydrochloric acid and purified titanium compounds can be recovered after dissolution, solvent extraction, and hydrolysis.

Ilmenite ores in nature, however, are often altered or “weathered”. In such ores, the iron oxide has been partially converted to the ferric form, and some of the TiO₂ in the original ilmenite has been converted to rutile, leucoxene, or another insoluble or partially soluble form. Moderately weathered ores can be treated by dissolution in concentrated hydrochloric acid following the process disclosed in U.S. Pat. No. 6,375,923, but as the amount of weathering or alteration increases, the efficiency of the leaching operation decreases, the amount of TiO₂ left in the residue increases, and the process becomes uneconomical.

### SUMMARY

It has now been found that it is possible to submit weathered ilmenite ores or, in general, titaniferous ores that cannot be leached or digested with good efficiency, to a simple pretreatment step that enhances the recovery of TiO₂ in solution and significantly improves the economics of the leaching or digestion process. With this simple pretreatment step it is possible to economically treat ore containing TiO₂ not only as ilmenite, but also ores containing a sizable fraction of TiO₂ as anatase, rutile, leucoxene, or other insoluble titanium oxide compounds. The simple pretreatment step is also particularly well suited to the treatment of heavy mineral concentrates produced from the mineral phase of oil sand deposits.

Titaniferous ores exhibiting low solubility in concentrated hydrochloric acid will be called refractory ores in the context of the present invention. A refractory titaniferous ore is mixed with one or more iron compounds and heated to a temperature at which reaction occurs between the iron compounds and the insoluble titanium compounds to produce soluble titanium compounds.

Preferably, the iron compounds include iron oxide, iron metal, or a mixture. The amount of iron metal and iron oxide needed is determined by the amount of TiO₂, the amount of ferrous and ferric oxide in the ore, as well as by other factors such as the organic content of the ore and the conditions of the heat treatment. The heating is typically conducted in a furnace under controlled atmosphere. The added iron compounds and the atmosphere content are selected and/or adjusted to create conditions that are intermediate between strongly oxidizing and strongly reducing conditions. If the conditions are too oxidizing or too reducing, the solubility of Ti in strong acid will decrease rather than increase after treatment.

These additions are characterized by the amount of iron and oxygen contained. The amount of iron and oxygen may vary over a wide range. Preferably, the amount of iron and oxygen will be equivalent to the amount of non-ilmenite TiO₂ present in the ore. If Fe₂O₃ or other oxidizing oxides are present in the ore, the amount of oxygen in the additions should be decreased. If a significant amount of organic compounds is present, the amount of oxygen should be increased.

The pretreatment step should be performed at a suitably high temperature to insure good reaction kinetics. If the temperature is too high, however, significant sintering occurs and the resulting product may need to be crushed and milled before further processing.

### BRIEF DESCRIPTION OF THE DRAWINGS

FIGS. 1 to 3 show the amounts of the different iron and titanium compounds that are stable under different conditions of temperature and oxidation potential.

FIG. 4 is a flow sheet of a preferred embodiment of the process according to the present invention.

FIG. 5 shows an X-Ray diffraction pattern of a titanium ore concentrate to which a mixture of iron powder and iron oxide has been added, before heating of the mixture.

FIG. 6 shows the X-Ray diffraction pattern of FIG. 5, after heating and reaction to 1050° C. for 3 h.

### DESCRIPTION

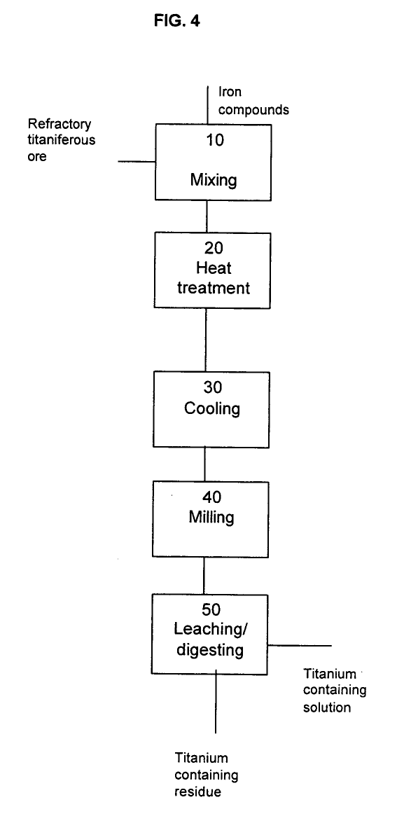

A refractory titanium dioxide ore concentrate is subjected to the following steps, shown schematically in FIG. 4.

A titaniferous ore or ore concentrate is mixed 10 with an iron compound selected from iron oxide, iron metal, or a mixture of iron oxide and iron metal. The iron oxide may be Fe₂O₃, FeO, Fe₃O₄, or any intermediate oxide. The iron oxide may be an oxidized iron ore. Examples of oxidized iron ores are hematite, magnetite, wustite, jarosite and goethite. The iron oxide may also be obtained from oxide layers, called oxide scale, formed during the milling of steel. The iron metal may be in the form of a powder or a coarse material. A small particle size (<1 mm) is preferred for the iron compounds, because it provides good contact between the different components. The mixing process may be performed by any means. The mixing process 10 may also be combined with a comminution, granulating, or pelletizing operation to bring the mixture to the required physical conditions for the next step of the operation.

A preliminary estimate for the amount of iron compound required is based on the chemical reaction between TiO₂ in the ore and FeO in the additive as:
TiO₂+FeO→FeO.TiO₂ (ilmenite)

FeO can be added as such or an equivalent amount of FeO can be obtained by mixing iron metal and iron oxides in such a way that the iron/oxygen molar ratio in this mixture is equal to 1.

In practice, there are a number of factors that influence the amount of iron compound to be used: if TiO₂ in the ore is in part present as an iron-titanium oxide (for example ilmenite, leucoxene, or pseudobrookite) the required amount of iron oxide will be decreased. If the ore already contains iron oxide minerals, the amount of required iron oxide in the additive will be decreased. If the ore contains components that have a chemical reducing action, such as pyrite or other sulfides, or organic compounds (for example oil residue left in concentrates obtained from oil sands), the iron to oxygen ratio should be reduced. If the total amount and the reactivity of oxidizing or reducing compounds in the ore and the iron compounds are accurately known, the required amount of the iron compound can be calculated on the basis of the stoichiometry of oxidation and reduction reactions. In practice, however, this is generally not the case, and the optimum amount of iron compound may have to be determined by trial and error. In general, the amount of equivalent FeO to be added is in the range of 5 to 50 weight % of the amount of ore concentrate.

The mixture of 10 is heated 20 to a temperature between 300° C. and 1200° C. In this temperature range, the iron compounds react with the titanium compounds to produce iron-titanium compounds. The heating 20 may be accomplished by suitable means known to those of skill in the art. The heating 20 may be accomplished in a directly or indirectly heated furnace or kiln. If the furnace is directly heated, a neutral atmosphere must be maintained. A rotary kiln may be advantageously used to insure good homogeneity of a powdered feed, and to yield a porous granulated product that can be used as such in the next step.

If the temperature is too low, the reaction kinetics will be too slow. If the temperature is at the higher end of the indicated range, sintering of the mixture may occur and the product may tend to form a solid mass that cannot conveniently be retrieved from a furnace and will require extra processing steps to make a feed usable for a leaching/digestion operation. In general, a temperature range of from about 900° C. to about 1100° C. is preferred.

The mixture is kept at temperature for a time in the range of 10 min to 8 h. In general, however, 2 h is sufficient to insure good reaction.

For a concentrate made from oil sands, a preferred temperature is about 1050° C.±30° C. If the mixture is formed from an oil sands concentrate, the heating step may be used to simultaneously remove organic residues from the concentrate.

Without being bound by any theory, the following thermodynamic calculations may explain some of the features of the invention. All calculations are based on a number of simplifying assumptions. The main assumption is that thermodynamic equilibrium is reached, i.e., that there are no kinetic limitations. Another assumption in the calculation is that the solid phases are soluble into each other and that the components behave as ideal solid solutions.

Thermodynamic equilibrium data are available in the literature for titanium and iron oxides, as well as for a number of titanium-iron oxides. Examples of titanium-iron oxides are FeO.TiO₂ (ilmenite), Fe₂O₃.TiO₂ (pseudobrookite), Fe₂O₃.3TiO₂ (pseudorutile) and 2FeO.TiO₂ (ulvospinel).

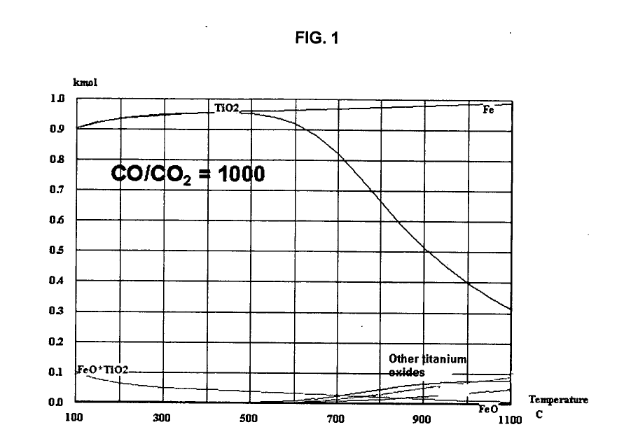

The reaction data shown below are calculated with the commercially available program HSC, sold by Outokumpu Research, Pori, Finland, and the equilibrium diagrams of FIGS. 1-3 are produced from the HSC program.

Oxidation Reactions

The reaction
2FeO.TiO₂+½O₂→Fe₂O₃.TiO₂+TiO₂ (1)
has a standard free energy of reaction ΔG of −146 kJ/mol at 500° C. and −96 kJ/mol at 1000° C. The reaction therefore favors completion of the reaction over a temperature range from about 300° C. to about 1200° C.
Reduction

The reaction
Fe₂O₃.TiO₂+H₂→2FeO+TiO₂+H₂O (2)
has a standard free energy ΔG of −17 kJ/mol at 500° C. and of −45 kJ/mol at 1000° C. It also favors completion of the reaction over temperature range from about 500° C. to about 2000° C.
Formation of Ilmenite
Fe+Fe₂O₃+3TiO₂→3FeO.TiO₂ (3)
and
FeO+TiO₂→FeO.TiO₂ (4)

The reaction (3) has a free energy of −87 kJ/mol at 500° C. and −104 kJ/mol at 1000° C. The reaction (4) has a free energy of reaction of −21 kJ/mol at 500° C. and −18 kJ/mol at 1000° C. Both reactions go entirely to the right.

Whereas treatment under oxygen or hydrogen will form some TiO₂, treatment with FeO, or the equivalent quantities of Fe and Fe₂O₃, without the intervention of a gas phase, will, at equilibrium, transform insoluble TiO₂ into soluble ilmenite.

The phenomena involved can be presented in a more general way by calculating the equilibrium state of a mixture of FeO and TiO₂ at different oxidation levels. The results of the calculations are shown in FIGS. 1, 2, and 3. The assumptions are that 1 mol of FeO and 1 mol of TiO₂ are brought in equilibrium at different temperatures under an atmosphere of varying oxidation potential, characterized by its CO/CO₂ ratio. The assumptions also include ideal solubility of the oxides into each other.

FIG. 1 shows that under reducing conditions, with a CO/CO₂ equilibrium ratio of 1000 in the gas phase, the compounds present at equilibrium are mostly TiO₂ and Fe, with a small amount of ilmenite at low temperature and a mixture of other titanium oxides at higher temperature.

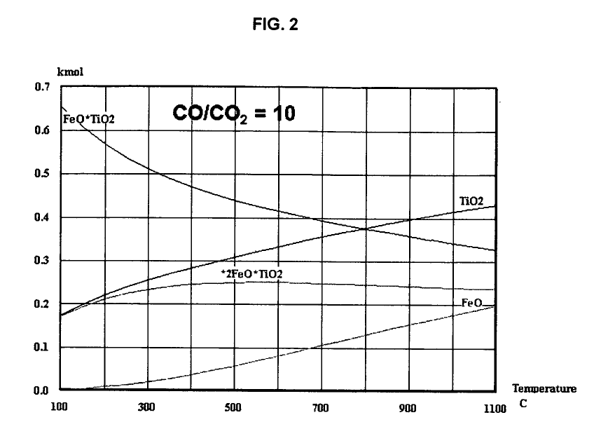

FIG. 2 shows that when the conditions become more oxidizing (CO/CO₂=10), iron metal is no longer stable, but ilmenite is the main stable species up to 800° C. The compound 2FeO.TiO₂ (ulvospinel) is also present. Even at the higher temperatures, ilmenite and ulvospinel taken together will bind the majority of the titanium in the system.

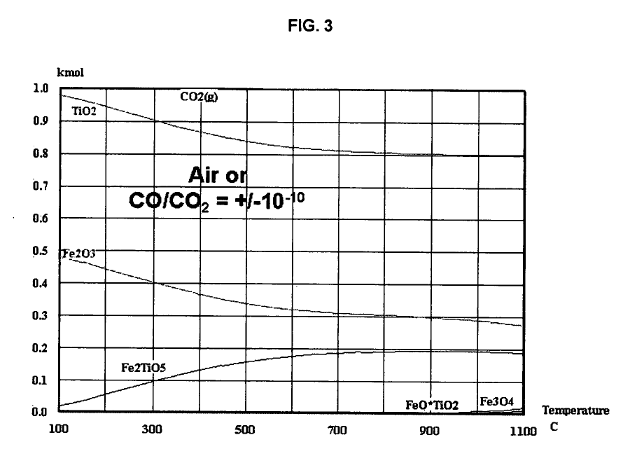

FIG. 3 shows the equilibrium species in the same system as FIGS. 1 and 2, but where the gas phase consists of air. TiO₂ and Fe₂O₃ are the main species, while a smaller amount of Fe₂TiO₅ (which can also be written Fe₂O₃.TiO₂) is present.

FIGS. 1, 2, and 3 taken together show that while a TiO₂ and FeO mixture leaves most of the titanium as TiO₂ both in reducing and oxidizing conditions, there is a range of intermediate oxygen potentials or CO/CO₂ ratios, where ilmenite and ulvospinel are the main compounds at equilibrium.

After treatment at high temperature, the mixture is cooled 30 in a neutral atmosphere. If air is present, oxidation will occur during cooling 30 and oxidized Fe—Ti oxide compounds may be formed, which will reduce the solubility of Ti in hydrochloric acid solution.

The product of the present invention is intended to be further processed in a leaching or digestion process. Therefore, it is desirable if the product has a relatively small particle size. Desirably, the particles have a size less than 1 mm, and more desirably less than 0.3 mm. For example, if sintering has occurred during the high temperature treatment, the product of step 3 should be milled. Milling 40 may be done by any means. A ball mill or a hammer mill may be used. If the particles produced in step 3 are larger than 1 mm but have high porosity, milling may not be needed.

In another embodiment of the present invention, the adjustment of the oxidation potential may be done through the gas phase, without requiring iron to be in a specific form. Referring to FIGS. 1, 2, and 3, one can see that if a mixture containing TiO₂ and iron oxides is put in the presence of a gas phase with a CO/CO₂ ratio of 10, ilmenite (FeO.TiO₂) and ulvospinel (2FeO.SiO₂) phases will be formed at equilibrium. Following this principle, it is possible to solubilize Ti from an oxide ore containing any iron oxide without addition of other compounds. If the amount of iron in the titaniferous concentrate is too small; some iron ore can be added. The cost of the iron compound will be significantly lowered if the use of iron metal or of large amounts of iron oxide can be avoided.

The iron compound added to the refractory titaniferous ore may be an iron sulfide such as pyrite, marcassite, pyrrhotite, or mixtures thereof. The iron sulfide will make iron available for reaction, but will have a reducing action. Air or another oxidizing gas will be introduced during heat treatment to increase the oxygen potential to the desired level. Certain titaniferous ores contain iron sulfide. In such an instance, additions may not be required and it will only be necessary to add an oxidizing gas to bring the oxygen potential to the required level.

The description of the process so far refers to a titaniferous ore. The process may also be advantageously employed to treat other oxidized titaniferous compounds, i.e. compounds where titanium is present as an oxide. It can also be used to treat intermediate products formed during the process of concentrating titaniferous ore or separating the minerals (e.g. rutile, leucoxene and ilmenite) contained in the ore. Examples of such intermediate products are middlings of a dry milling operation or residues of a preliminary leaching operation.

### EXAMPLES

The following is a description of small-scale tests where mixtures of TiO₂ or a titaniferous ore concentrate are mixed with iron powder, ferric, or ferrous oxide and are then roasted under different conditions.

The tests used reagent grade Fe powder and Fe₂O₃ added to a sample of concentrate containing about 30% TiO₂.

Table I shows the different proportions of heavy mineral concentrate and of the iron compounds used. This table also shows the results of leaching tests performed on these samples. The leaching tests are described in the following section.

In Test 1, no pretreatment was applied. In Test 2,500 g of concentrate was heated to 500° C. under a flow of argon for about 5 h. Test 3 was conducted under the same conditions as Test 2, except that the temperature was raised to 900° C. and that the flow of argon was replaced by a flow of hydrogen.

For Tests 4 to 13, reagent grade iron and iron oxide powders were mixed with about 500 g of heavy mineral concentrate obtained from oil sands tailings.

Test 4 was run in a muffle furnace in an air atmosphere for about 5 h. The samples were mixed for 5 min in a ball mill and then placed in cylindrical Al₂O₃ crucibles (with the assumption that the oil content of the sands would maintain a non-oxidizing atmosphere). The sample product was ground for thirty minutes in a ball mill.

The experimental method for Test 5 was similar to that of Test 4. The samples were mixed in a ball mill and then roasted in a muffle furnace. The resulting sample was also ground to powder in a ball mill for thirty minutes.

In tests 6, 7, and 8,500 g of heavy mineral concentrate were combined with varying amounts of reagent grade Fe powder and Fe₂O₃ and roasted in an oven at 850° C. The amount of iron and Fe₂O₃ are given in Table I. Test 7 had the concentrate mixed with Fe powder only, and test 8 consisted of concentrate mixed with Fe₂O₃ only. Test 6 consisted of concentrate with additions of both Fe and Fe₂O₃. Each sample was mixed in a ball mill for 10 min and roasted for roughly 5 hr. After roasting, all samples were ground using the ball mill and leached in a 10 gal Pfaudler reactor.

Samples from tests 9, 10, and 11 combined 500 g of concentrate with additions of Fe powder and Fe₂O₃ and were roasted at 1050° C. for about 5 hr. Test 12 was the same as 9, except that the temperature was raised to 1150° C.

Test 12 combined 500 g of concentrate with additions of Fe powder and Fe₂O₃. The samples were mixed by hand. The mixture was roasted in the oven at 1142° C. for 4 hr. The product had sintered as porous mass after reaction. It was ground using a combination of pestle and mortar and ring-and-puck mill.

For test 13, FeO was synthesized by mixing 143 g Fe and 357 g Fe₂O₃ and roasting at 950° C. for 4 hrs in a closed crucible. The FeO was ground using a pestle and mortar and sieved using a No. 40 screen. An amount of 166 g of FeO was then added to 500 g of the concentrate. The sample was mixed by hand and roasted at 1050° C. for 5 hr. The product was ground using pestle and mortar and sieved using the No. 40 screen (<425 μm).

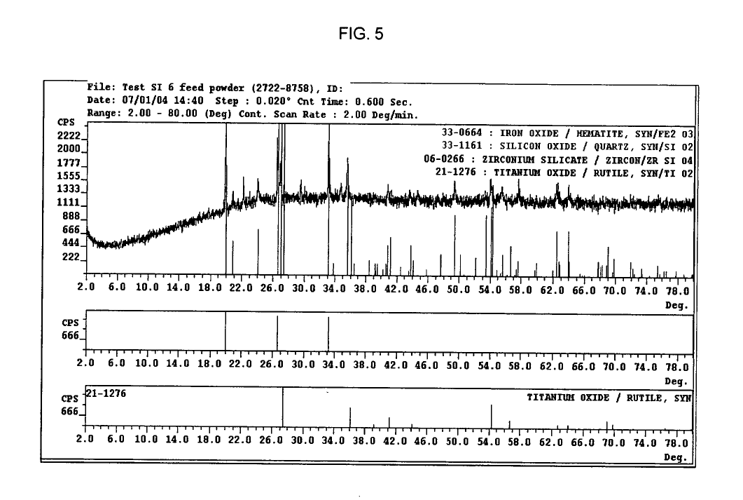

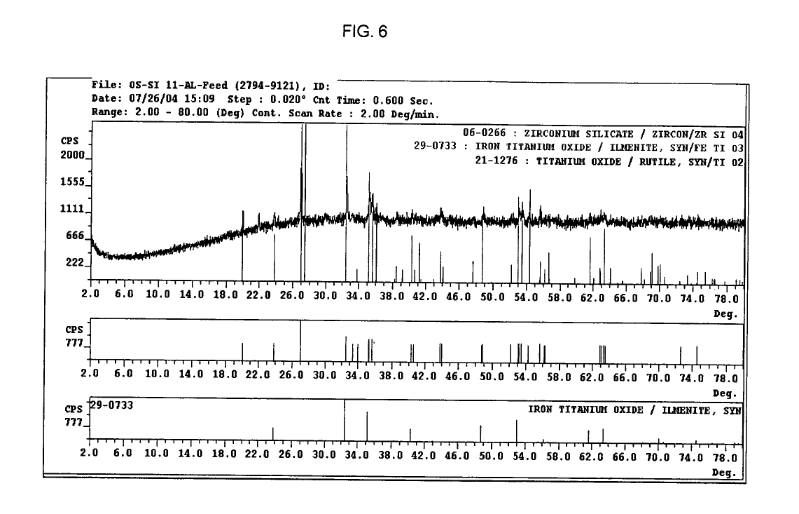

X-Ray diffraction patterns of the mixtures before roasting show peaks corresponding to hematite, silica, and zirconia. Sometimes a small peak corresponding to rutile is visible. No ilmenite is visible. After roasting, the hematite peak disappears and ilmenite appears. FIG. 5 corresponds to the feed mixture of Tests 5, 6, and 10. FIG. 6 corresponds to the product of Test 10, i.e. it shows the material of FIG. 5 after it has been processed at 1050° C. The pattern shows well-defined peaks of ilmenite, which are not present in FIG. 5, whereas the hematite present in FIG. 5 has disappeared.

To confirm that the roasting process made the titanium in the ore more soluble and amenable to leaching, the product was treated as follows:

An amount of 20 liters of concentrated hydrochloric acid solution (35 weight % HCl) was fed to a 10 gallon, stirred glass-lined, Pfaudler reactor. The products of each of the tests 1 to 13 of the previous section were added to the reactor in separate runs. The reactor was closed and hot water was passed through the reactor water jackets to bring the contents to 80° C. A pressure of about 30 psig built up in the reactor. Every hour, a sample was taken out of the reactor and analyzed for titanium and iron. After 5 h of reaction, the reactor was cooled by passing cold water through the jackets. The reactor was emptied; the solids were recovered on a filter, washed, and dried. The volume of the product solution was measured, and a sample was taken for analysis. A mass balance for Ti, Fe, and the major impurities was established and the amount of Ti and Fe dissolved in each test expressed as a % of the amount in the feed was calculated. The results for each test are given in Table I.

TABLE 1

| | | % of Ti in | % of Fe in |
|---|---|---|---|
| Test | Conditions of pretreatment | solution | solution |
| 1 | No pretreatment | 18 | 43 |
| 2 | Heated to 500° C. under Ar. | 19 | 58 |
| 3 | Heated to 900° C. under hydrogen | 4 | 85 |
| 4 | Addition of 25% Fe₂O₃, 3.5% Fe, heated to 988° C. under | 50 | 93 |
| | Ar | | |
| 5 | Addition of 37% Fe₂O₃, 13% Fe, heated to 950° C. in | 52 | 96 |
| | closed crucible | | |
| 6 | Addition of 37% Fe₂O₃, 13% Fe, heated to 850° C. in | 47 | 97 |
| | closed crucible | | |
| 7 | Addition of 13% Fe, heated to 850° C. in closed | 32 | 92 |
| | crucible | | |
| 8 | Addition of 37% Fe₂O₃, heated to 850° C. in closed | 37 | 95 |
| | crucible | | |
| 9 | Addition of 25% Fe₂O₃, 9% Fe, heated to 1050° C. in | 71 | 94 |
| | closed crucible | | |
| 10 | Addition of 37% Fe₂O₃, 13% Fe, heated to 1050° C. | 79 | 98 |
| | in closed crucible | | |
| 11 | Addition of 55% Fe₂O₃, 19% Fe, heated to 1050° C. | 82 | 99 |
| | in closed crucible | | |
| 12 | Addition of 25% Fe₂O₃, 9% Fe, heated to 1150° C. in | 60 | 89 |
| | closed crucible | | |
| 13 | Addition of 33% FeO, heated to 1050° C. in closed | 68 | 90 |
| | crucible | | |

Test 1 gives the reference point. It shows that only 18% of the Ti and 43% of the Fe dissolved from the ore concentrate as provided. Test 2 shows that heating under argon has only a small effect on the results. Test 3 corresponds to reducing conditions with the reducing agent being hydrogen gas. This test shows a decreased solubility of Ti and an increased solubility of Fe. These results are consistent with a mechanism corresponding to reaction (2): reduction liberates iron oxide which is well soluble and TiO₂ which is not.

The results of the tests conducted with iron and/or iron oxide additions show that the most complete dissolution of Ti is obtained at 1050° C. with the highest additions of Fe₂O₃ and Fe. Comparing Test 9 and 13 shows that the addition of FeO is also effective, although the amount of Ti in solution was slightly smaller than for a similar amount of iron added as Fe₂O₃+Fe. For an industrial process, the cost of the reagents and of the pretreatment step has to be taken into account, and the most economic conditions may not be the ones giving the highest proportion of Ti in solution.

Besides the addition of Fe and iron oxides, other methods can be used to adjust the oxidation level of the ore concentrate and convert iron oxide-titanium oxide mixtures totally or partially to soluble titanium-iron oxide compounds and increase the solubility of Ti in the ore concentrate. For example, mixtures of CO and CO₂, mixtures of H₂ and H₂O, or gases from the combustion of fuel in relatively reducing conditions can be used. The temperature will be in the range of 500 to 1200° C. Thermodynamic calculations similar to those presented in FIGS. 1-3 can be used to determine the conditions required.

While there have been described what are presently believed to be the preferred embodiments of the invention, those skilled in the art will realize that changes and modifications may be made thereto without departing from the spirit of the invention. It is intended to claim all such changes and modifications that fall within the true scope of the invention.

What is claimed:

1. A pretreatment method for oxidized titanium compounds, titaniferous ore, ore concentrate or mixtures thereof, comprising:
a. adding an iron compound to an oxidized titanium compound, titaniferous ore, ore concentrate or mixtures thereof, and mixing to form a mixture;
b. heating the mixture under a controlled atmosphere for a period of time to form an iron-titanium compound;
c. cooling the iron-titanium compound; and,
d. milling the iron-titanium compound to produce a powder suitable for dissolution in hydrochloric acid.

2. The method of claim 1 where the iron compound is selected from the group consisting of iron powder, ferrous oxide, ferric oxide, and mixtures thereof.

3. The method of claim 1 where the iron compound is ferrous oxide.

4. The method of claim 2 where the iron compound is a mixture of iron powder and ferric oxide present in stoichiometrically equivalent amount to the amount of free TiO₂ present in the ore, based on the reaction Fe+Fe₂O₃+3TiO₂=3FeO.TiO₂.

5. The method of claim 3 where the amount of ferrous oxide added is stoichiometrically equivalent to the amount of free TiO₂ present in the ore, based on the reaction FeO+TiO₂=FeO.TiO₂.

6. The method of claim 1 where the heating is performed at a temperature between 500° and 1200° C.

7. The method of claim 1 where the heating is performed at a temperature between 1000° and 1100° C.

8. The method of claim 1 where the heating is performed under a neutral atmosphere.

9. The method of claim 6 where the heating is performed under a neutral atmosphere.

10. The method of claim 4 where the amount of the iron compound is adjusted to take into account the reducing effect of an oil residue in the ore.

11. The method of claim 1 wherein the solubility in concentrated hydrochloric acid of titanium in the powder is at least 1.5 times the solubility of the titanium in the titaniferous ore or ore concentrate.

12. A synthetic compound formed by reaction of a refractory titaniferous ore with an iron compound.

13. The synthetic compound of claim 12 where the iron compound is ferrous iron.

14. The synthetic compound of claim 12 where the iron compound is a mixture of ferric iron and iron powder.

15. The synthetic compound of claim 12 where the refractory titaniferous ore includes a compound selected from the group consisting of rutile, anatase, leucoxene, brookite, pseudobrookite, pseudorutile, and mixtures thereof.

16. The synthetic compound of claim 12 where the solubility in concentrated hydrochloric acid of titanium in the synthetic compound is at least 1.5 times the solubility of the titanium in the refractory titaniferous ore under the same conditions.

17. A pretreatment method for a titaniferous ore or ore concentrate, comprising:
a. adding an iron compound to the titaniferous ore or ore concentrate and mixig to form a mixture;
b. heating the mixture under a controlled atmosphere;
c. adjusting the oxygen potential of the system to a value corresponding to the stability of ilmenite and FeO.TiO₂;
d. maintaining the oxygen potential for a period of time from about 2 h to about 12 h;
e. cooling the mixture to form an intermediate product; and,
f. milling the intermediate product to produce a powder.

18. The method of claim 17 where the atmosphere is controlled by passing a mixture of CO and CO₂ over the solid mixture.

19. The method of claim 17 where the atmosphere is controlled by passing a mixture of H₂ and H₂O over the solid mixture.

20. The method of claim 17 wherein the iron compound is an iron sulfide.
